(19) United States
(12) Patent Application Publication
(10) Pub. No.: US 2011/0119111 A1
(43) Pub. Date: May 19, 2011

(54) Measuring Effectiveness of Advertisements and Linking Certain Consumer Activities Including Purchases to Other Activities of the Consumer

(75) Inventor: Keith J. Hanna, New York, NY (US)

(73) Assignee: GLOBAL RAINMAKERS, INC., New York, NY (US)

(21) Appl. No.: 12/600,338

(22) Filed: Nov. 16, 2009

(51) Int. Cl. G06Q 30/00; G06Q 10/00

(52) U.S. Cl. 705/7.33; 705/14.43; 705/14.53; 705/14.45; 705/14.51

(57) ABSTRACT

A method for linking online computer activity with non-online consumer activity by creating a unique identifier for each consumer; storing online and non-online consumer activity in a database indexed by the unique identifier; and modifying online or non-online consumer offerings based on processing the stored online and non-online consumer activity.

### CROSS-REFERENCE TO RELATED APPLICATIONS

This application claims benefit of U.S. provisional application 60/939,038, filed May 18, 2007, which is hereby incorporated by reference in its entirety.

### BACKGROUND OF THE INVENTION

With the growth of online purchasing activity, several methods have been developed that aim to optimize the information presented to the consumer in order to maximize the likelihood that the information is useful to the consumer, and maximize the likelihood that the consumer will make a purchase from a particular retailer.

The activities of a consumer however are becoming more disparate and widespread. For example, consumers freely switch between browsing for information both online, in retail stores, and in many other consumer locations. An advertising billboard for a product may appear in a mall, but it is very difficult to determine whether that particular billboard led to increased sales of a product. In another example, a consumer may obtain product information online but then buy the product in a retail store. Conversely, a consumer may obtain information in a retail store but buy the product online.

In other situations a consumer may purchase an airline ticket online, appear in person at the airport check-in counter, appear in person at the baggage claim area for the flight for which the ticket was purchased, and then may appear in person at a car rental counter. The consumer may then surf the Internet for tourist information, restaurants, and even emergency services.

In U.S. Pat. Publications US 2006/0041472, US 2005/0038698, US 2004/0225555, US 2002/0042738 examples of methods of displaying messages or determining targeted information based on the profile of a consumer are disclosed. These methods however use secondary information on the consumer's activity. For example, in US 2004/022555, the names of individuals and their affiliated institutions are identified in published materials and cross-referenced with bulk purchases of materials from institutions in an attempt to link particular purchases. This method is inaccurate and can only address the purchasing activity in a very narrow segment of the population in a very narrow market sector. This publication does not address linking very disparate customer actions such as observing an advertisement in a mall and buying the product in a retail store.

U.S. Pat. Nos. 6,957,770, 7,152,045, 7,318,050, and 7,273,168 disclose methods that use biometrics for authenticating transactions. The disclosed methods, however, do not address the problem of linking consumer activity across multiple or even single locations, between online activities and in person activities, and also require that the user associate their biometric with a bank account or other institution that may be highly valued and protected by the consumer.

### SUMMARY OF THE INVENTION

There is a need in the art of computer implemented marketing to consumers to more efficiently identify an individual when the individual conducts an online activity or in person activity, or appears at a particular monitored location, whether at a single location or at disparate locations, and then without necessarily identifying the individual by name, bank account, social security number, or credit card account number, and to automatically associate the individual's disparate activities to improve the effectiveness of advertising and marketing. With the present invention, the advertisements presented to the individual consumer may be optimized and further the consumer's activities may be made more efficient.

In one aspect of this invention, a method is provided for relating consumer activity across such multiple locations utilizing biometrics without necessarily knowing the name or credit card information of the consumer. The method links the consumer activity without knowing the identity of the individual. This can overcome privacy and other concerns that individuals may have.

An aspect of this invention addresses a need in the financial services industry to curtail and/or eliminate fraud at the point of sale, i.e., a location where a consumer executes a transaction in a retail environment, as well as at a point where the consumer executes a financial transaction electronically in an online manner using the consumer's credit or debit card or other token device wherein a number is uniquely associated with the name and the identity of the consumer.

The invention not only enables on-line advertisers to acquire a general demographic profile of an aggregation of consumers who click on the on-line advertisements, but it also enables the advertisers know the specific identities of the consumers as well.

Further, the invention enables on-line searches executed by an individual consumer to be linked with the purchasing behavior of that consumer at points of sale, thus enabling a feedback mechanism by which advertisers can effectively gain knowledge of:
1. The amount of time that lapses from when a consumer clicks on an advertisement to when he/she purchases the product or service related to the ad; and
2. Whether or not the consumer actually did purchase the product or service of the advertisement on which they clicked.

Specifically, a given consumer at one location and/or activity is linked with the same consumer at another location and/or activity. For example, the consumer may simply be present at an airport, departing on a particular flight to a particular location. The consumer at that particular instant of time and at that particular airport, is then linked with another activity at a later instant of time, e.g., renting a car at another location. Significantly, the linking of the consumer from one event or activity to another event or activity may be performed without knowledge of the person's identity. In some applications, or in countries where privacy concerns limit the storing of names and other personal information, this capability is a substantial benefit. Moreover, if the consumer is presented with an advertisement or a coupon at or near the time of the first location or activity, then the consumer's response at a later time to the coupon or advertisement can be quantified by associating that consumer to the point of purchase.

### BRIEF DESCRIPTION OF THE DRAWINGS

The features and advantages of the invention will be appreciated by reference to the detailed description when considered in connection with the attached drawings wherein:

FIG. 1 is a block diagram illustrating an overview of a first embodiment of the invention where an individual's biometrics are acquired at a first location and stored in a database along with data related to the consumer's activity at the first location and then at a second location a set of biometric data is acquired, processed, and if a match is made, the processing system associates the activity at the first location with the activity at the second location.

FIG. 2 is a block diagram illustrating an embodiment of the invention wherein an individual registers, receives information during online activity, and offerings are targeted or customized based on information from the individual's prior activity.

FIG. 3 is a block diagram illustrating an embodiment wherein a personal computer is used at a first location to acquire an individual's identification which is stored on a remote data storage system and then at a second location the individual is identified using either a card swipe device or a keyboard or mouse input to a processor 4, 7.

FIG. 4 is a block diagram illustrating an embodiment with biometric registration to identify a consumer and then offerings are presented which are customized based on the individual's online activity.

FIG. 5 is a block diagram of the remote storage aspect of the system illustrated in FIG. 4 wherein a biometric capture device 1 is used or a keyboard and mouse 5 are used to acquire data which can be used to identify an individual, wherein the data is stored in a database.

### DETAILED DESCRIPTION OF THE INVENTION

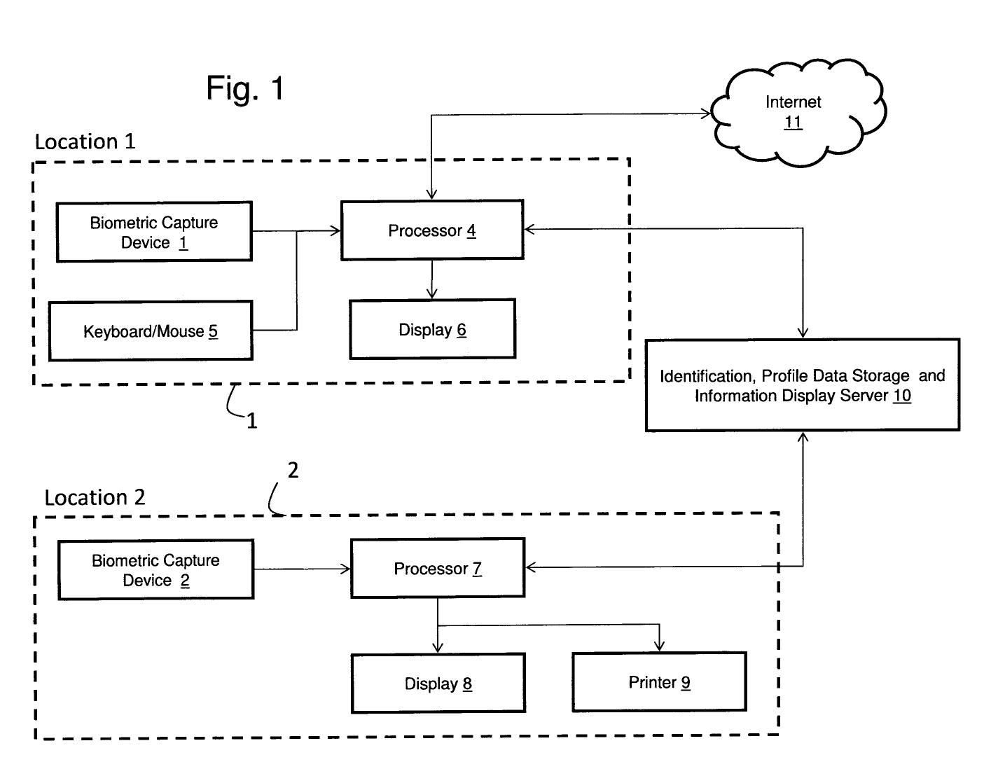

Referring first to FIG. 1, a first embodiment of the invention is illustrated wherein a consumer is at a first location and views an advertisement on a display device 8 such as a computer screen or billboard. The location may be online, or may be in a bus shelter. The consumer then presents their biometric information, such as the iris, to a device adjacent to the display device 6 such as a web camera capable of recording iris imagery. A processor 4 collects the biometric information and transmits it to a remote server that stores the biometric data and indexes it to the particular advertisement that was on display 6 at the time the biometric data was collected. This biometric data collection process can occur repeatedly any time the consumer has interest in a particular product or service that is displayed. At a second location, the consumer presents their biometric once again to a second biometric collection device. The second location may be a retail store in which the product advertised at the first location is sold. A remote identification and profile data storage server performs a biometric search and identifies the same biometric that was collected at the first location. The link between the advertisement at location 1 and the consumer's activity at location 2 is then stored in the database. FIG. 1 shows the process flow by which the user either at the beginning of an online session or periodically during the session registers themselves If they have interest in obtaining a discount or have other Benefit. They may do this by browsing web pages through a GRI portal that keeps track of the pages being viewed, and then offers occasionally that if they provide their iris or credit card Information then they can receive discounts when at a retail store or other special real service. When the customer reaches a real consumer location, A swipe of their credit card on a device can display and perhaps print out a special offer as a basis of their online monitoring. This can be used to get a special discount at the store for example. Information that the consumer Went to the device at the store and got the coupons is then used to modify the profile of the consumer and the advertisements that are presented to them.

In a further aspect of the invention, the biometric of the consumer is read at location 1, the remote database server is interrogated and a biometric search is performed in order to locate the index of the consumer's prior activities. Based on the consumer's prior activities, a different advertisement is presented to the consumer.

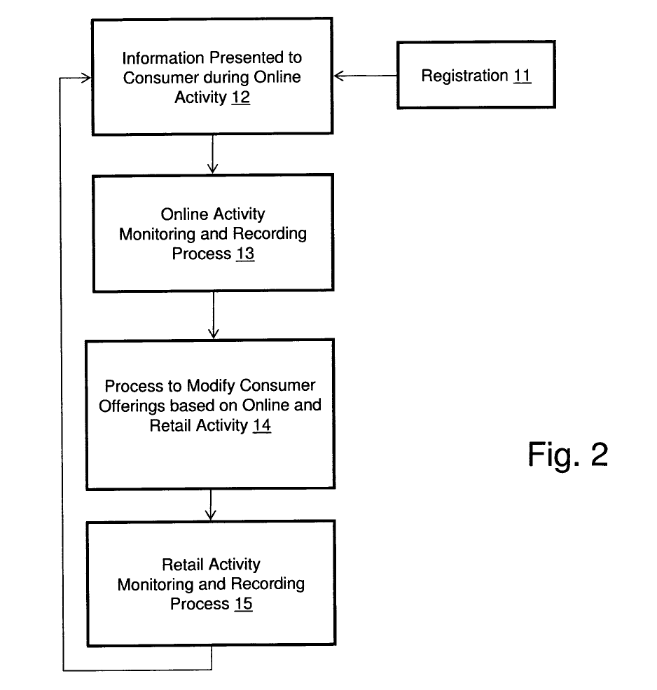

Referring now to FIG. 2, a process flow for the first embodiment is illustrated wherein location 1 is an online location.

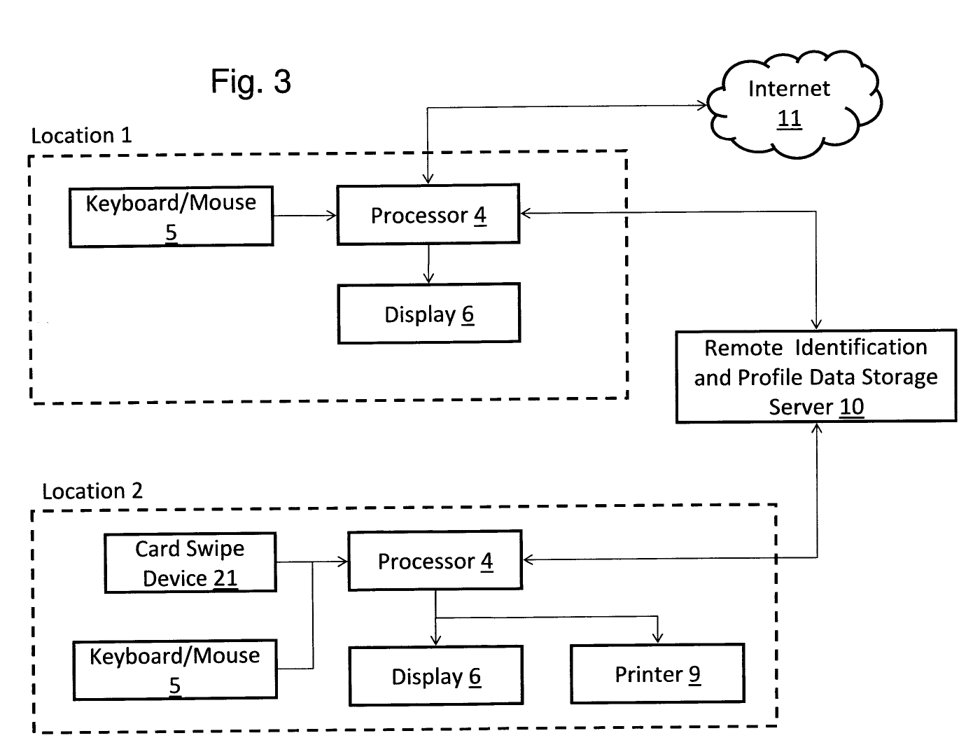

A second embodiment of the invention is illustrated in FIG. 3 wherein the name, card number or other number unique to the consumer is collected and sent to the local processor 4. When a particular advertisement is displayed, the consumer registers their potential interest in the advertisement. This can be performed by a simple mouse click. The identifying information is then transmitted to the remote server where it is stored and indexed to the particular advertisement that was on display at the time. At a retail store, the consumer swipes their card or enters in their identifying number. The remote identification and profile data storage server uses this unique information to index into the advertisements that were shown in the first location. The link between the advertisement at location 1 and the consumer's activity at location 2 is then stored in the database. This diagram shows an implementation of FIG. 1 just using credit card number information.

There are several incentives for the consumer to participate in such linkage processes, such as discounts at the point of purchase. In FIG. 3, an optional printer 9 prints out a coupon that the consumer can redeem at the store in order to obtain a discount, as one incentive to participate.

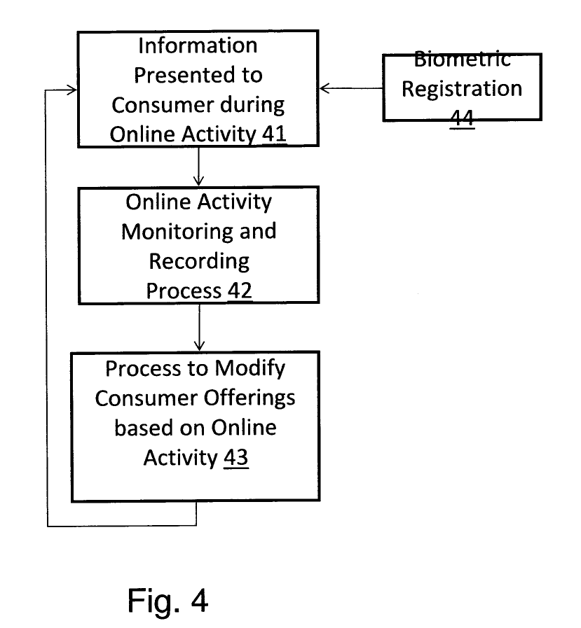

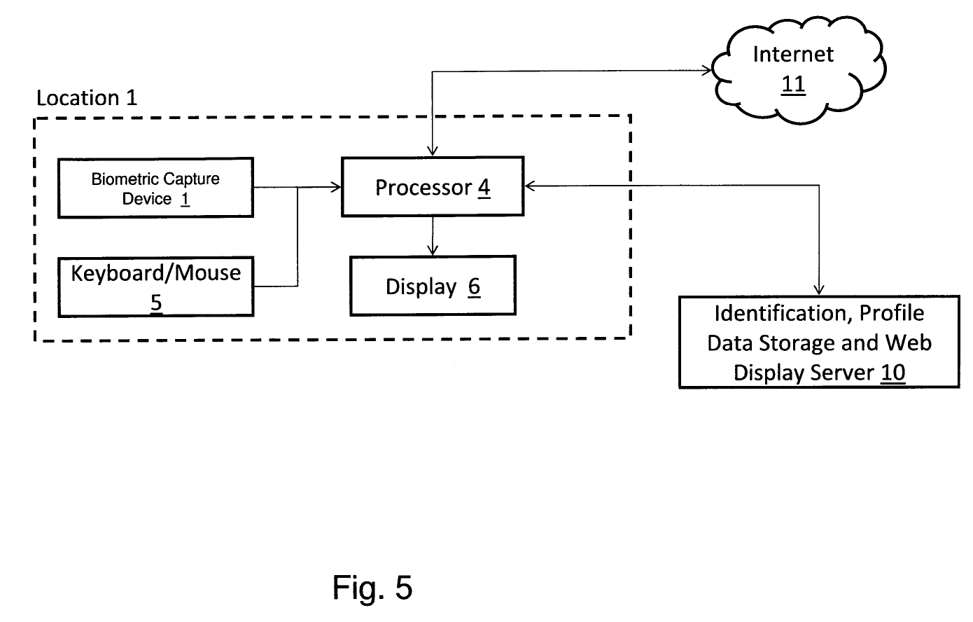

In a second aspect of the invention, the linkage processes are performed solely online as shown in FIG. 4. The user presents their iris during a registration process which may occur only once at the beginning of an online session, or at one or more particular time instants during the online session when a particular online process is being performed or data is displayed. Information is displayed to the user based on the linkage information that has been recovered from the user's previous online activities. The user's current online activities (transactions for example) are monitored and used to modify the information presented to the user. Specific embodiments are shown in FIG. 5. In FIG. 5, the user registers their biometric using a biometric capture device 1 attached to their personal computer, such as a webcam. The user's biometric data is collected as the user browses or performs transactions using the internet. The biometric data and an index to the activity information is sent to a remote server. The biometric data is then matched against the biometric data held in the database and a link is recorded in the database between the activity indices at the one or more additional time instants that the match process recovers. Based on the results of the link, the remote processor 10 modifies the data displayed 6 or sent to the user. For example, the user may be provided with a coupon or code that provides a discount at an online or retail store. FIG. 5 shows an implementation of FIG. 4 using remote storage of the user biometric identification and profile data.

A detailed example of one embodiment of the invention follows. First a consumer is presented with an ad or a coupon via a display on a cell phone or a computer screen. Next, it is noted whether or not the consumer responds to the ad or coupon, for example, by the consumer having clicked on the displayed ad. Alternately, the consumer is simply physically present at a particular event or location that is associated with a particular product or service, such as at an airport gate where the consumer is departing to a particular location. Then a device reads one or more biometric features of the consumer at any point in time that allows the consumer to be associated with the presentation of the ad or coupon. A preferred biometric is one that allows the most unique associations. For example, an iris biometric is highly accurate.

The biometric of the user (biometric1) as read is stored in a database, along with metadata including location, time, advertisement index, and, optionally, information on whether or not the user expressed interest in the presented advertisement or coupon.

At a later instant of time, a second device reads the biometric of the user (Set n) at a time or place associated to a particular product or service. A biometric search is then performed through the biometric database using Set n+1 as a reference. Optionally, additional information that may be available, such as the name of the consumer, can be used to limit the number of records that are searched. It is noted that no such name or limiting information is necessarily required, however.

When one or matches are located, associations are formed between set n and set n++1. This is implemented by storing in a database index numbers relating to set n and set n++1.

Any data that associates (i) the consumer's presence at a location and/or performing a particular activity, the consumer's being presented with an ad or coupon, and/or responding to the ad, with (ii) the consumer's later purchase of a product or service, or later presence at a location performing a particular activity; is then stored and made available to potentially interested manufacturers, service providers or other third parties, for a fee.

The invention also enables advertisers, as well as manufactures, to target consumers directly as they walk about in retail environments of any and all types.

Another aspect of the invention is a process to eliminate or reduce fraud in a purchase process, either at a physical point of sale or online. A biometric device is provided at the point of sale, e.g., a device that enables the acquisition of a biometric such as a fingerprint or an iris. The device is either connected with a terminal at the point of sale (e.g., a cash register or a credit/debit card reader), or the biometric device is unconnected with the terminal. The device enables a consumer at the point of sale to be identified positively as the person whose credit or debit card (or other identity based token) is being presented to effect payment on a commercial transaction at the point of sale.

The consumer presents a credit or debit card or other identity based token bearing the consumer's name and a uniquely identifying number, to a clerk at the point of sale whereupon the clerk requests the consumer to provide a biometric via the acquisition device. The consumer's biometric is then validated by forwarding to a back end server at a remote data processing center. A file in which the consumer's biometric was previously enrolled, is associated with the number appearing on the presented identity based card or token. A computer in the processing center sends a message to the point of sale terminal indicating that the biometric provided by the consumer matches the biometric residing in the back end server. The biometric provided at the point of sale may be referenced to the biometric residing in the server by means of a pointer that resides in, e.g. a magnetic stripe on the consumer's credit or debit card, or a chip on a smart card or other token device presented by the consumer. The transaction concludes at this point and an audit trail is established whereby a record of a transaction number with a date, the name of the consumer, the amount purchased, a photograph of the consumer and the captured biometric data are kept on file in the back end server at the remote center.

While the invention has been described an illustrated in considerable detail, various alternative embodiments and modifications should become readily apparent to those skilled in this art without departing from the spirit and scope of the invention.

What is claimed is:

1. A method for linking online computer activity with non-online consumer activity by:
a) creating a unique identifier for each consumer;
b) storing online and non-online consumer activity in a database indexed by the unique identifier; and
c) modifying online or non-online consumer offerings based on processing the stored online and non-online consumer activity.

2. The method of claim 1 where the identifier is solely biometric data.

3. The method of claim 1 where the identifier is credit card information

4. A method for associating the identity of an individual to particular online activity by
(a) collecting biometric data as a consumer clicks on or observes a particular web page or advertisement;
(b) storing said biometric data locally or remotely indexed with the web-page or advertisement that was viewed when said biometric data was collected; and
(c) matching said biometric data with previously collected biometric data to obtain a linked series of web pages and advertisements.

5. A computer implemented method of associating commercial activities on an individual comprising acquiring a set of biometric data from an individual at a time of a first activity; storing the set of biometric data in a database as set n; acquiring a set of biometric data from an individual at second time and storing the second set of biometric data in the database as set n+1; using a biometric identification algorithm to determine if set n and set n+1 identify the same individual within a predetermined probability; if set n and set n+1 identify the same individual, associating the first activity and the second activity; and based on the association between the first activity and the second activity, providing customized advertising or marketing information to the identified individual at the time of the second activity or at the time of a subsequent activity.

6. The method of claim 5 wherein the first activity is selected from the group consisting of online shopping, online purchase, online photo upload, online registration at a web site; appearing in person at a store, airport, car rental counter, and billboard; electronically presenting a credit card for a purchase; and
passing through a biometric data capture location.

7. The method of claim 5 wherein the first and subsequent activities are independently selected from the group consisting of online shopping, online purchase, online photo upload, online registration at a web site; appearing in person at a store, airport, car rental counter, and billboard; electronically presenting a credit card for a purchase; and passing through a biometric data capture location.

8. A method for profiling an individual based on the individual's commercial activities and using the profile to assist the individual with subsequent activities comprising acquiring a set of biometric data from an individual at a time of a first activity and creating a profile of the individual which does not include private information; storing the set of biometric data in a database as set n; acquiring a set of biometric data from an individual at second time and storing the second set of biometric data in the database as set n+1; using a biometric identification algorithm to determine if set n and set n+1 identify the same individual within a predetermined probability; if set n and set n+1 identify the same individual, storing the first activity and the second activity within the profile; and using the profile to associate the individual with prior commercial activities at the time of a subsequent commercial activity.
